(19) United States
(12) Patent Application Publication
(10) Pub. No.: US 2026/0115684 A1
(43) Pub. Date: Apr. 30, 2026

(54) Graphene composite material modified with coordinating group, method of preparation and use thereof

(71) Applicant: MING CHI UNIVERSITY OF TECHNOLOGY, New Taipei City (TW)

(72) Inventors: Yi Ting LAI, New Taipei City (TW); Chen Chieh LIAO, New Taipei City (TW)

(21) Appl. No.: 19/008,562

(22) Filed: Jan. 2, 2025

(30) Foreign Application Priority Data
Mar. 20, 2024 (TW) 113110348

(51) Int. Cl. B01J 20/20; B01J 20/22; B01J 20/28; B01J 20/30; B01J 20/32; C02F 1/28; C02F 1/30; C02F 101/20; C02F 101/22

(52) U.S. Cl. CPC B01J 20/20; B01J 20/22; B01J 20/28028; B01J 20/3085; B01J 20/3225; B01J 20/3293; C02F 1/288; C02F 1/30; C02F 1/283; C02F 1/285; C02F 2101/203; C02F 2101/206; C02F 2101/22; C02F 2303/16

(57) ABSTRACT

The present invention relates to a graphene composite material modified with coordinating group, method of preparation and use thereof, especially a graphene oxide (GO) modified with ethylenediamine group or a reduced graphene oxide (rGO) formed by silanization which may be applied to wastewater treatment equipment to adsorb various heavy metals in contaminated water. The present invention also relates to a method to remove heavy metal ions from wastewater contaminated by heavy metal utilizing a graphene composite material modified with coordinating group.

### CROSS-REFERENCE TO RELATED APPLICATIONS

This application claims the benefit of priority of Taiwan Application Number TW113110348, filed on 20 Mar. 2024, which is herein incorporated by reference in its entirety.

### TECHNICAL FILED

The present invention relates to a graphene composite material modified with coordinating group, especially a graphene oxide (GO) modified with ethylenediamine group or a reduced graphene oxide (rGO) formed by silanization which may be applied to wastewater treatment equipment to adsorb various heavy metals in contaminated water.

### BACKGROUND

The contamination issue of the wastewater containing heavy metals become more severe in pace with the industrialization. This would fatally impact human health, including brain injuries, nervous system disorders, cancers, organ dysfunction, kidney and lung injuries, gastrointestinal disorders, skin injuries and the like.

There are about 45 types of common heavy metals, for example, Au, Ag, Cu, Pb, Hg, Cr, Zn, Ti, V, Mn, As, Ni, Cd and the like. Based on different types of heavy metal contamination, a number of treatment technologies have been developed and can be divided into three groups: chemical treatment method, physical treatment method, biological treatment method. There are several types of chemical treatment methods as well. Among them, heavy metal capturing method uses heavy metal capturing agent, which is also known as heavy metal chelator, to capture heavy metals. Common capturing agents include DTC, EDTA and the like and can be categorized into two types: chelating agents and chelating resins according to the difference of functional groups and structures between the capturing agents. Chelating agent is a linear single structure, soluble in water, and specialized in heavy metal waste liquids, while chelating resin has a three-dimensional structure, are not water-soluble, and are mostly used for precious metal recovery. There are several types of physical treatment method as well. Among them, adsorption method utilizes the porosity, the large specific surface area, and the rich functional groups of the adsorbent, so that the heavy metal ions may form covalent or ionic bonds with the functional groups, and be adsorbed on the surface or in the pores such that the heavy metals are removed. The examples of adsorbent include lignin, sawdust, iron oxides, activated carbon, nanoparticles, and graphene oxide and the like.

Graphene oxide (GO) has a large specific surface area and is rich in oxygen-containing functional groups, thereby being an excellent sorbent with high efficiency and high adsorption capacity. Although graphene oxide and graphene both demonstrate a hexagonal lattice structure, the former has a large amount of oxygen-containing functional groups, including epoxy group (C—O—C) and hydroxyl group (C—OH) on the surface and carboxyl group (COOH) and carbonyl group (C═O) in the peripheral region, thereby creating a three-dimensional structure of sp² and sp³ mixture in graphene oxide rather than a two-dimensional structure as that of graphene. Also, the structural property of graphene oxide endows graphene oxide with chemical properties easily modified, amphiphilic properties (being hydrophilic and lipophilic), high dispersibility in water, and rich surface functional group.

However, graphene oxide is prone to aggregation, which limits its development in wastewater treatment applications. Furthermore, the low selectivity of graphene oxide for pollutants makes it harder to be applied in wastewater treatment in practice as well, because wastewater contains various other substances which may compete for the reaction active sites on graphene oxide, thus reducing the adsorption capacity of graphene oxide on heavy metals.

### SUMMARY

According to the issues above, the present invention is intended to provides a sorbent with large adsorption capacity and high efficiency. The present invention takes advantage of graphene oxide (GO) or reduced graphene oxide (rGO) and combines them with the chelating functional group of heavy metal capturing agent, ethylenediamine (also called EDA), or its derivatives. The present invention may be applied in wastewater treatment equipment and adsorb various heavy metals in the polluted water.

N-[3-(trimethoxysilyl)propyl]ethylenediamine (EDA-silane) used in the present invention is an organosilicon compound commonly used in surface treatment and material synthesis. Its molecular structure includes one ethylenediamine molecular group and one trimethoxysilyl functional group.

In the molecular structure of EDA-silane, EDA portion equips it with two amino functional groups, rendering it to have good chemical reactivity in surface treatment and be able to bind various active groups on surface to form bonding, which leads to an improvement in adhesion of material, enhancement of performance, or change in its surface properties. On the other hand, trimethoxysilyl functional group can undergo silanization with the surface of many inorganic materials (such as metal, glass and the like) to form stable chemical bonds, thereby realizing a good combination of organic and inorganic materials.

In the art of material synthesis, EDA can also be used as crosslinking or coupling agent to react with surface of metal to form surface modification layer to improve the corrosion resistance, abrasion resistance and adhesion of the metal, and at the same time, improve the compatibility between the metal and the organic material or coating, enhancing the overall performance and stability of the material.

In an aspect, the present invention provides a graphene composite material modified with coordinating group, characterized by comprising a substrate comprising fibrous material or porous material and graphene oxide (GO) or reduced graphene oxide (rGO) which is modified with coordinating group and coated on the substrate and/or coated within the substrate;
the coordinating groups are ethylenediamine groups covalently bonded to the graphene oxide (GO) or the reduced graphene oxide (rGO) via linking group;
the ratio of the basic unit of the graphene oxide (GO) or the reduced graphene oxide (rGO) to the coordinating group is 1:0.4 to 1:0.8;
the weight ratio of the substrate to the graphene oxide (GO) or the reduced graphene oxide (rGO) is 0.5:1 to 0.7:1.

In some embodiments, the fibrous material described in the present invention, for example, is natural fiber fabric or a synthetic fiber fabric and the like, and the porous material described in the present invention, for example, is synthetic sponge or natural sponge and the like.

In some embodiments, the porous material substrate comprises various natural or synthetic material with multiple porous structures and also comprises the described fibrous material. In one example, melamine sponge is used as substrate.

In some embodiments, the linking group is —O—Si(—CH₂)ₘ(—OR)₂—; wherein R is H, C₁-C₄ alkyl or absent, and m=1-4.

In some embodiments, the ratio of the basic unit to the coordinating group in the graphene oxide (GO) or the reduced graphene oxide (rGO) is 1:0.5 to 1:0.7, preferably 1:0.6 to 1:0.7. In one example, the ratio of the basic unit to the coordinating group in the graphene oxide (GO) is 1:0.6475.

In some embodiments, the weight ratio of substrate to the graphene oxide (GO) or the reduced graphene oxide (rGO) is about 0.6:1.

In another aspect, the present invention provides a method to prepare the graphene composite material modified with coordinating group described above, characterized by comprising:
(i) immersing the substrate in a graphene oxide solution for 0.5-2 hours, wherein the substrate is fibrous material or porous material;
(ii) adding 0.1-15% N-[3-(trimethoxysily)propyl]-ethylenediamine (EDA silane) solution at 50˜70° C. to perform silanization for 1-12 hours such that the hydroxyl group (—OH) of the surface of the graphene oxide reacts with the silicon in the EDA silane to form silane-bridging;
(iii) adding methanol, deionized water to remove EDA silane which has not reacted with the graphene oxide after the silanization is completed;
(iv) repeating the steps (ii)˜(iii) for 2-3 times to obtain graphene oxide modified with EDA (EDA-GO).

In some embodiments, the method comprises further reducing the graphene oxide modified with EDA to reduced graphene oxide modified with EDA (EDA-rGO).

In another aspect, the present invention provides a use of the graphene composite material modified with coordinating group described above, characterized by being used to adsorb at least one of the following heavy metals in wastewater treatment equipment: mercury ions, cadmium ions, cobalt ions, lead ions, manganese ions, magnesium ions, iron ions, copper ions, nickel ions, zinc ions, chromium ions.

In yet another aspect, the present invention provides a method to remove heavy metal ions from wastewater contaminated by heavy metal, characterized by comprising:
(i) Arranging the graphene composite material modified with coordinating group of the present invention in a filter;
(ii) allowing the wastewater contaminated by heavy metal pass through the filter, wherein the graphene composite material modified with coordinating group of the present invention can adsorb the heavy metal comprising at least one of the following: mercury ions, cadmium ions, cobalt ions, lead ions, manganese ions, magnesium ions, iron ions, copper ions, nickel ions, zinc ions, chromium ions in the wastewater;
(iii) degrading the heavy metal by photodegradation of the graphene composite material modified with coordinating group.

The EDA and GO in the graphene composite material modified with coordinating group of the present invention are connected via silane-bridging and immobilized on, for example, a sponge and/or within a sponge to improve the performance of the composite material and enhance bonding strength, thereby be able to be used to adsorb many kinds of heavy metals with high adsorption capacity and high adsorption efficiency.

Further, EDA-rGO composite material obtained by reducing the EDA-GO composite material of the present invention also exhibits the same adsorption effects and better conductivity, rendering it to be further applied in electro-adsorption.

In addition, the present invention adopts interval EDA silanization and perform silanization for at least 2 or 3 times. Compared with one-step EDA silanization, the present invention can remove EDA-silane in instable bonding and enhance the covalent bonding between EDA-silane and graphene oxide, thereby enhancing the adsorption ability, adsorption efficiency and stability of the graphene oxide composite material modified with EDA toward heavy metals.

### BRIEF DESCRIPTION OF THE DRAWINGS

FIG. 1 represents schematic diagram of manufacturing the graphene oxide modified with EDA (EDA-GO) composite material and the reduced graphene oxide modified with EDA (EDA-rGO) composite material of the present invention.

FIG. 2 represents that the present invention adopts interval EDA silanization and perform silanization for at least 2 or 3 times to enhance the covalent bonding between EDA-silane and GO, thereby enhancing adsorption ability, adsorption efficiency and stability of EDA-GO composite material toward metal ions.

FIG. 3A and FIG. 3B represent an EDA-GO sponge obtained by adopting sponge with different thickness as substrate in an exemplary manufacturing method, wherein the sponge in FIG. 3A has a thickness of 2 cm and the sponge in FIG. 3B has a thickness of 0.5 cm.

FIG. 4 represents the fourier-transform infrared (FTIR) spectrum of graphene sponge, GO sponge and EDA-GO sponge.

FIG. 5 represents the Raman spectrum of GO sponge and EDA-GO sponge.

FIG. 6A and FIG. 6B represent the X-ray photoelectron spectroscopy (XPS) analysis of GO sponge and EDA-GO sponge, wherein FIG. 6A is C1s XPS spectrum and FIG. 6B is O1s XPS spectrum.

FIG. 7A and FIG. 7B represent the SEM images and SEM-EDS elemental analysis images of GO sponge adsorbing Cu (FIG. 7A) and EDA-GO sponge adsorbing Cu (FIG. 7B).

FIG. 8 represents the result of adsorption capacity test of the EDA-GO sponge of the present invention toward Cu ions.

FIG. 9A, FIG. 9B and FIG. 9C represent the result of adsorption kinetics test of EDA-GO sponge of the present invention and GO without modification toward Cu ions, wherein FIG. 9A represents the adsorption kinetics curves of GO sponge and EDA-GO sponge; FIG. 9B represents Pseudo-first order kinetic model linearization and analysis; and FIG. 9C represents Pseudo-second order kinetic model linearization and analysis.

FIG. 10 represents the test result of EDA-GO sponge of the present invention adsorbing different kinds of heavy metals.

FIG. 11 represents the schematic diagram of degrading heavy metals adsorbed by EDA-GO sponge by photodegradation technology.

FIG. 12 represents the degradation effect of EDA-GO sponge adsorbing heavy metals after photodegradation treatment, which is detected by absorbance of methylene blue.

### DETAILED DESCRIPTION

The embodiments of the present invention will be disclosed below, and they are intended to illustrate details of the present invention and effects after implemented, rather than limit the present invention to be implemented as disclosed below.

### [Preparation of EDA-Graphene Oxide (EDA-GO) Composite Material]

As shown in FIG. 1, the sponge was cut into sponges having sizes of 2 cm×2 cm×0.5 cm, 2 cm×2 cm×1 cm, or 2 cm×2 cm×2 cm, then immersed in 5 mg/ml graphene oxide solution for 1 hour and then dried in oven to obtain graphene oxide sponge material (GO sponge), wherein the weight ratio of the sponges to the graphene oxide is about 61%. Next, the graphene oxide sponge material was immersed in 100 ml 3% N-[3-(trimethoxysilyl)propyl] ethylenediamine (EDA-silane) solution at 60-65° C. to perform silanization for 6 hours. After the reaction is completed, the material was dried with the oven and then the obtained EDA-GO sponge was immersed in methanol, deionized water and sonicated for 15 minutes to remove EDA silane which has not bonded with the GO. Then, the EDA-GO sponge was dried with the oven again. The steps of silanization and washing described above were repeated 2 or 3 times to obtain the EDA-GO sponge material of the present invention.

### [Preparation of EDA-Reduced Graphene Oxide (EDA-rGO) Composite Material]

Optionally, the EDA-GO sponge material of the present invention was immersed in reductant (such as hydrazine) to be reduced to EDA-reduced graphene oxide (EDA-rGO).

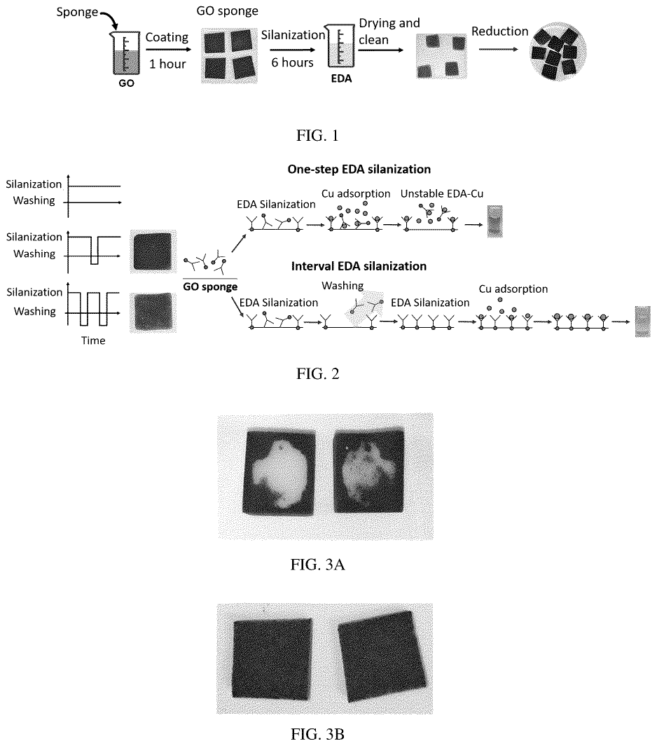

As shown in FIG. 2, with interval silanization and EDA-silane modification reaction and subsequential washing repeated for at least 2 or 3 times, EDA-GO sponge of the present invention can remove EDA-silane in instable bonding, further enhance the bonding strength of EDA-GO composite material, and enhance the adsorption ability, adsorption efficiency and stability toward heavy metals compared with one-step EDA silanization.

The “basic unit” of graphene oxide or reduced graphene oxide described in the present invention means each basic graphene oxide unit or reduced graphene oxide unit, comprising a single carbon atom with any functionalized group associated with it.

The “silane” described in the present invention means silicon-containing silane compound having a Y—(CH₂)ₙ—Si—X₃ structure, wherein n=1-2; X is a hydrolysable group; Y is an organic functional group such as coordinating group. Typically, X is chloro group, methoxy group, ethoxy group, methoxyethoxy group, acetyloxy group or the like. These groups form (Si(OH)₃) when hydrolyzed and combine with graphene oxide to form siloxane. Y is vinyl group, amine group, epoxy group, methacryloxy group, mercapto group or ureido group. These reactive groups can react and combine with organic substance. Thus, by using silane coupling agent, “molecular bridging”, i.e., the silane-bridging of the present invention, can be established between surfaces of inorganic substance and organic substance to connect two kinds of materials with distinct properties together and improve the properties of the composite material and bonding strength.

The rich carboxyl groups on the surface after EDA modification indicate increased adsorption sites to further enhance adsorption capacity and adsorption efficiency in the EDA-GO composite material of the present invention in which covalent bonding is formed by the silanization between hydroxyl group on the surface of GO and silicon of EDA-silane. The EDA-GO sponges prepared by the steps described above are shown in FIG. 3A and FIG. 3B, wherein the sponge in FIG. 3A has a thickness of 2 cm and the sponge in FIG. 3B has a thickness of 0.5 cm.

The properties and adsorption effects toward heavy metals of the EDA-GO composite material or the EDA-rGO composite material of the present invention is further tested in the following examples.

### EXAMPLES

### [Fourier-Transform Infrared (FTIR) Spectrum Analysis]

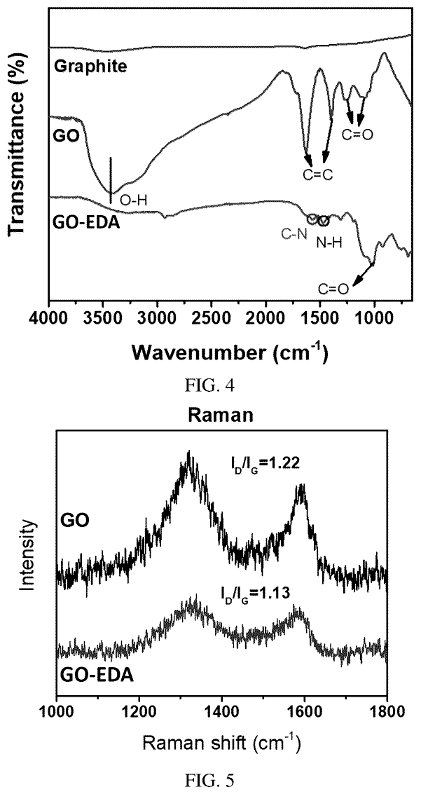

The functional groups and bonding states of the synthesized EDA-GO composite material in the present invention was evaluated with FTIR spectrum, and FTIR spectrum of EDA-GO was compared with those of graphene and GO without modification. The results are shown in FIG. 4. A peak of 1431 cm⁻¹ was resulted from stretching vibration of O—H. A peak of 1249 cm⁻¹ was resulted from stretching vibration caused by C—O of carboxyl group (—COOH) and carbonyl group (C═O). A peak of 1083 cm⁻¹ was present and showed a slight shift in FTIR spectrum of GO without modification and EDA-GO composite material of the present invention. The framework vibration (C═C) of the unoxidized part of GO resulted in a peak of 1618 cm⁻¹. A peak of 1569 cm⁻¹ and a peak of 1469 cm⁻¹ represented the C—N bond and N—H bond of EDA in EDA-GO composite material of the present invention respectively.

### [Raman Spectrum Analysis]

The Raman spectrum of EDA-GO composite material of the present invention was compared with that of GO without modification; wherein the D-band characterized defective structure resulted from hybrid and disorder of sp³ of carbon in GO and the G-band characterized the structure resulted from hybrid and order carbon of sp² in the two-dimensional hexagons of graphene. Therefore, the intensity ratio of the D-band and the G-band (Ip/IG) represented the ratios of defective structure and disorder structure in the framework of graphene qualitatively. As shown in FIG. 5, the Ip/IG value of GO without modification was 1.22, which was higher than that of EDA-GO composite material, 1.13. It was evaluated that there was increased surface defect of GO in the graphene oxide composite material modified with EDA due to the embedded EDA molecules.

### [X-Ray Photoelectron Spectroscopy (XPS) Analysis]

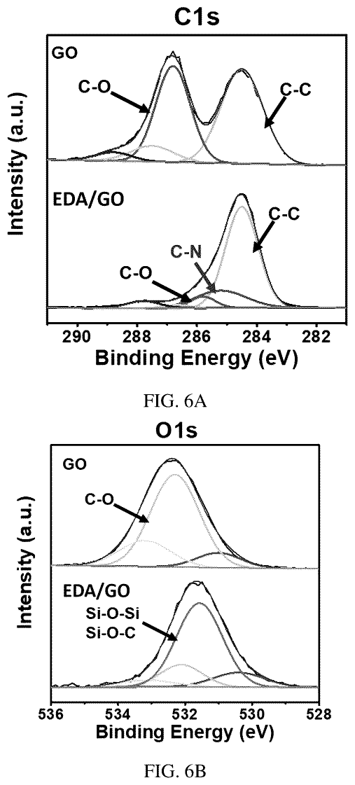

The XPS spectrum of EDA-GO composite material of the present invention was compared with that of GO without modification. As shown in FIG. 6A and FIG. 6B, FIG. 6A and FIG. 6B represented C1s XPS spectrum and O1s XPS spectrum respectively. As shown in FIG. 6A, the spectral line characterizing C—N bond in EDA was present in GO composite material modified with EDA of the present invention. Also, due to the silane-bridging connecting EDA and GO resulted from the silanization between Si in EDA-silane and hydroxyl group (—OH) on the surface of GO, the spectral line characterizing the Si—O—C bond between the linking group of the present invention and GO and the spectral line characterizing Si—O—Si bond between the linking groups were present in FIG. 6B. In addition, the original C—O bond with hydroxyl groups was reduced. As further quantified, it was shown that the proportion of EDA in graphene oxide was about 64.57%.

### [Heavy Metals Adsorption Efficacy Test]

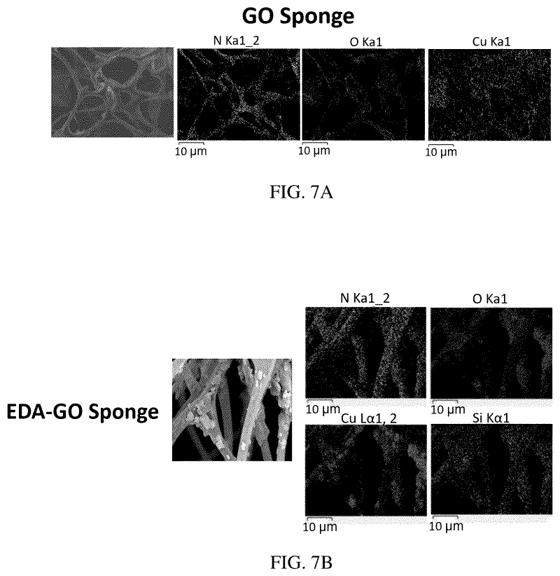

The EDA-GO sponge of the present invention was used to adsorb Cu ions, and GO sponge without modification was used as a control. As shown in FIG. 7A and FIG. 7B, the SEM images and SEM-EDS elemental analysis images demonstrated that, as shown in FIG. 7B, the EDA-GO sponge of the present invention could adsorb Cu ions effectively and formed aggregated particles in the sponge substrate. As shown in FIG. 7A, in the GO sponge, Cu ions were dispersed in the sponge substrate and failed to be adsorbed effectively.

Then, to simulate the application of graphene composite material modified with EDA of the present invention to heavy metals adsorption in polluted water filtration equipment, different sizes of EDA-GO sponges (2 cm×2 cm×0.5 cm or 2 cm×2 cm×1 cm respectively) were placed in the 2 cm×2 cm×15 cm flow duct with a flow pump cycled at 8 rpm to filter heavy metals in the aqueous solution sample. Sampling was conducted at different time points during filtration and inductively coupled plasma (ICP) was used to determine the concentration of heavy metal substances in filtered aqueous solution samples.

In this example, sample to be filtered was 250 ml of Cu aqueous solution with initial concentration of 100 ppm. The adsorption capacity was calculated by the following equation:

$$Adsorption Capacity = \frac{( {C}_{f} - {C}_{i} ) \times V}{W}$$

wherein C_{f} is the Cu concentration of filtered aqueous solution sample; Ci is the initial Cu concentration of aqueous solution sample before filtration; V is the volume of aqueous solution sample; and W is the weight of EDA-GO sponge.

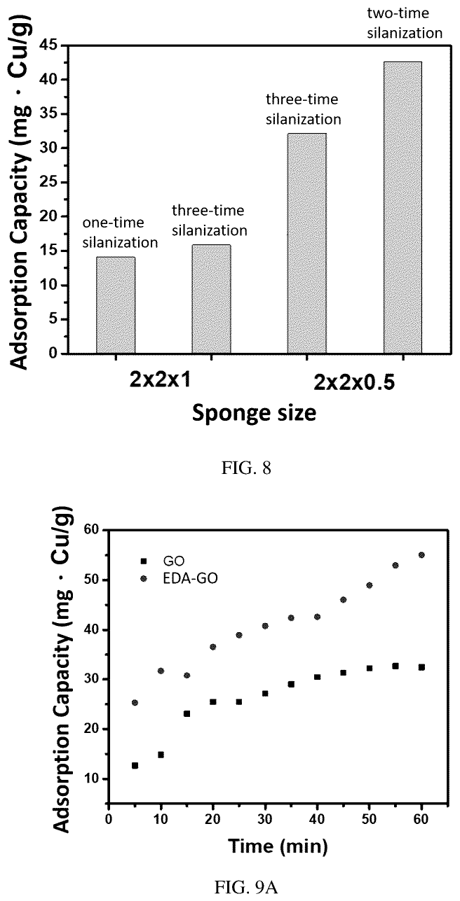

After the Cu aqueous solution were filtered with the EDA-GO sponges of the present invention for 30 minutes, the Cu concentration of the aqueous solution samples filtered with the EDA-GO sponges with a size of 2 cm×2 cm×1 cm underwent process of one-step silanization or three-time silanization were 97.66 ppm and 97.14 ppm respectively. By contrast, the Cu concentration of the aqueous solution samples filtered with the EDA-GO sponges with a size of 2 cm×2 cm×0.5 underwent process of three-time silanization or two-time silanization were 94.38 ppm and 91.05 ppm respectively. The result of adsorption capacity calculated by the equation above was shown in FIG. 8; wherein the adsorption capacity of the EDA-GO sponges with a size of 2 cm×2 cm×1 cm underwent process of one-step silanization was 13.99 mg·Cu/g, while the adsorption capacity of the EDA-GO sponges with a size of 2 cm×2 cm×0.5 cm underwent process of two-time silanization was 42.66 mg·Cu/g.

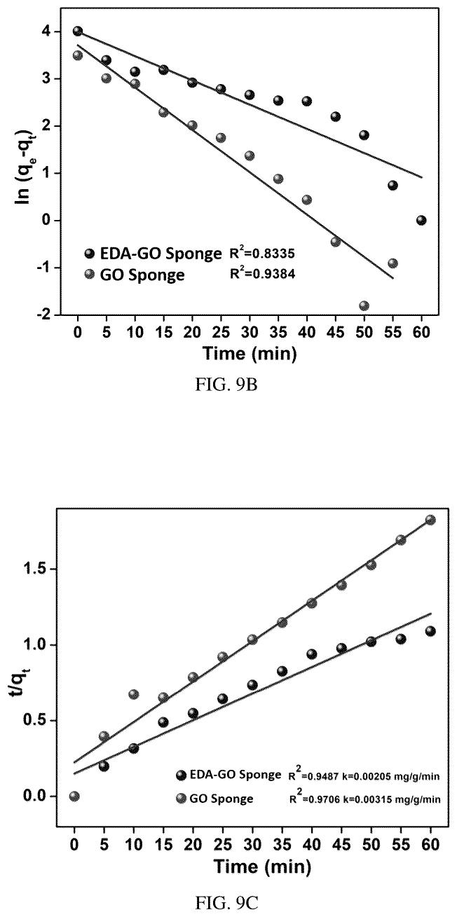

The adsorption kinetic experiment evaluated the impacts of reaction time on adsorption capacity primarily and the adsorption capacity at time versus time was plotted. The time required for system to reach a saturated adsorption can be obtained from adsorption kinetic curves. The adsorption kinetic test result of EDA-GO sponges of the present invention was compared with that of GO sponges without modification. As shown in FIG. 9A, the adsorption capacity of EDA-GO sponges of the present invention was far larger than that of GO sponges without modification, and at 60 minutes, the GO sponges were almost saturated while the adsorption capacity of the EDA-GO sponges of the present invention was still increasing. The adsorption rate constant and adsorption rate of the EDA-GO sponges of the present invention and the GO sponges were further analyzed. As shown in FIG. 9B and FIG. 9C, the GO sponges composite material modified with EDA of the present invention had a higher adsorption capacity and adsorption rate, which may be applied to wastewater treatment equipment with effective adsorption of heavy metals.

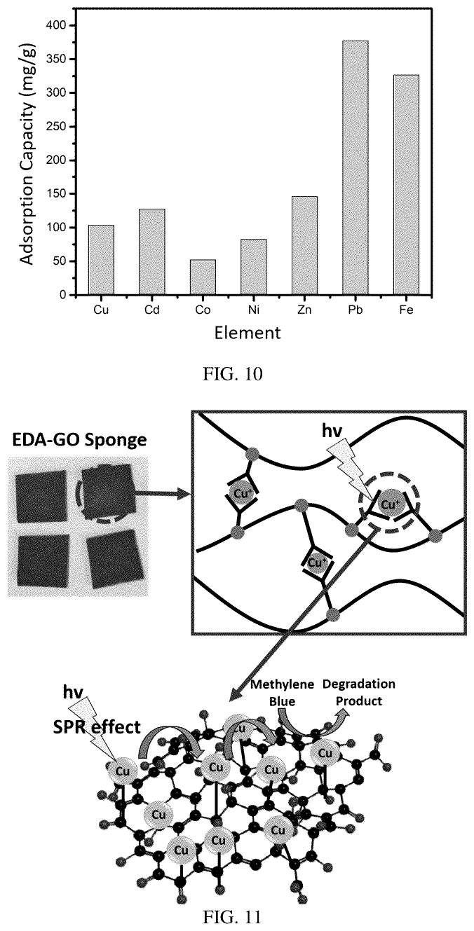

The following experiments detected the adsorption capacity of the EDA-GO sponges of the present invention toward various heavy metals. The samples to be filtered is 250 ml of aqueous solutions of various metal ions with an initial concentration of 100 ppm. After filtered with the EDA-GO sponges of the present invention for 1 hour, in the aqueous solution sample, the concentration of Cd is 69.46 ppm, the concentration of Co is 93.03 ppm, the concentration of Pb is 33.94 ppm, the concentration of Fe is 19.01 ppm, the concentration of Cu is 75.63 ppm, the concentration of Ni is 90.19 ppm, and the concentration of Zn is 74.41 ppm. As calculated with the equation above, the resulted adsorption capacity is shown in FIG. 10, wherein the adsorption capacity for Cu was 103.5 mg·Cu/g; the adsorption capacity for Cd was 127.46 mg·Cd/g; the adsorption capacity for Co was 52.17 mg·Co/g; the adsorption capacity for Ni was 82.69 mg·Ni/g; the adsorption capacity for Zn was 146.07 mg·Zn/g; the adsorption capacity for Pb was 377.05 mg·Pb/g; and the adsorption capacity for Fe was 326.57 mg·Fe/g. The result demonstrates that the GO sponges composite material modified with EDA of the present invention can adsorb various heavy metals effectively.

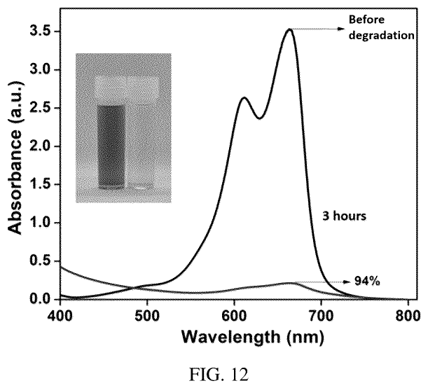

Further, after filtered with the EDA-GO sponges of the present invention, the adsorbed heavy metals therein were degraded by photodegradation technology, as shown in FIG. 11 to prevent the heavy metals from being released into the environment again and causing pollution. After the EDA-GO sponges with adsorbed heavy metals were treated with photodegradation for 3 hours, the degradation effect was detected with absorbance of methylene blue dye. As shown in FIG. 12, about 94% of the heavy metals had been degraded.

What is claimed is:

1. A graphene composite material modified with coordinating group, characterized by comprising a substrate comprising fibrous material or porous material and graphene oxide (GO) or reduced graphene oxide (rGO) which are modified with coordinating group and coated on the substrate and/or coated within the substrate;
the coordinating groups are ethylenediamine groups covalently bonded to the graphene oxide (GO) or the reduced graphene oxide (rGO) via linking group;
a ratio of a basic unit of the graphene oxide (GO) or the reduced graphene oxide (rGO) to the coordinating group is 1:0.4 to 1:0.8;
a weight ratio of the substrate to the graphene oxide (GO) or the reduced graphene oxide (rGO) is 0.5:1 to 0.7:1.

2. The graphene composite material modified with coordinating group of claim 1, wherein the substrate is a natural fiber fabric or a synthetic fiber fabric.

3. The graphene composite material modified with coordinating group of claim 1, wherein the substrate is synthetic sponge or natural sponge.

4. The graphene composite material modified with coordinating group of claim 1, wherein the linking group is —O—Si(—CH₂)ₘ(—OR)₂—; wherein R is H, C₁-C₄ alkyl or absent, and m=1-4.

5. A method to prepare the graphene composite material modified with coordinating group of claim 1, characterized by comprising:
(i) immersing a substrate in a graphene oxide solution for 0.5-2 hours, wherein the substrate is fibrous material or porous material;
(ii) adding 0.1-15% N-[3-(trimethoxysily)propyl]-ethylenediamine (EDA silane) solution at 50˜70° C. to perform silanization for 1-12 hours such that hydroxyl group (—OH) of surface of the graphene oxide reacts with silicon in the EDA silane to form silane-bridging;
(iii) adding methanol, deionized water to remove EDA silane which has not reacted with the graphene oxide after the silanization is completed;
(iv) repeating steps (ii)˜(iii) for 2-3 times to obtain graphene oxide modified with EDA (EDA-GO).

6. A method to prepare the graphene composite material modified with coordinating group of claim 2, characterized by comprising:
(i) immersing a substrate in a graphene oxide solution for 0.5-2 hours, wherein the substrate is fibrous material or porous material;
(ii) adding 0.1-15% N-[3-(trimethoxysily)propyl]-ethylenediamine (EDA silane) solution at 50˜70° C. to perform silanization for 1-12 hours such that hydroxyl group (—OH) of surface of the graphene oxide reacts with silicon in the EDA silane to form silane-bridging;
(iii) adding methanol, deionized water to remove EDA silane which has not reacted with the graphene oxide after the silanization is completed;
repeating steps (ii)˜(iii) for 2-3 times to obtain graphene oxide modified with EDA (EDA-GO).

7. A method to prepare the graphene composite material modified with coordinating group of claim 3, characterized by comprising:
(i) immersing a substrate in a graphene oxide solution for 0.5-2 hours, wherein the substrate is fibrous material or porous material;
(ii) adding 0.1-15% N-[3-(trimethoxysily)propyl]-ethylenediamine (EDA silane) solution at 50˜70° C. to perform silanization for 1-12 hours such that hydroxyl group (—OH) of surface of the graphene oxide reacts with silicon in the EDA silane to form silane-bridging;
(iii) adding methanol, deionized water to remove EDA silane which has not reacted with the graphene oxide after the silanization is completed;
repeating steps (ii)˜(iii) for 2-3 times to obtain graphene oxide modified with EDA (EDA-GO).

8. A method to prepare the graphene composite material modified with coordinating group of claim 4, characterized by comprising:
(i) immersing a substrate in a graphene oxide solution for 0.5-2 hours, wherein the substrate is fibrous material or porous material;
(ii) adding 0.1-15% N-[3-(trimethoxysily)propyl]-ethylenediamine (EDA silane) solution at 50˜70° C. to perform silanization for 1-12 hours such that hydroxyl group (—OH) of surface of the graphene oxide reacts with silicon in the EDA silane to form silane-bridging;
(iii) adding methanol, deionized water to remove EDA silane which has not reacted with the graphene oxide after the silanization is completed;
repeating steps (ii)˜(iii) for 2-3 times to obtain graphene oxide modified with EDA (EDA-GO).

9. The method of claim 5, further reducing the graphene oxide modified with EDA to reduced graphene oxide modified with EDA (EDA-rGO).

10. The method of claim 6, further reducing the graphene oxide modified with EDA to reduced graphene oxide modified with EDA (EDA-rGO).

11. The method of claim 7, further reducing the graphene oxide modified with EDA to reduced graphene oxide modified with EDA (EDA-rGO).

12. The method of claim 8, further reducing the graphene oxide modified with EDA to reduced graphene oxide modified with EDA (EDA-rGO).

13. A use of the graphene composite material modified with coordinating group of claim 1, characterized by being used to adsorb at least one of following heavy metals in wastewater treatment equipment: mercury ions, cadmium ions, cobalt ions, lead ions, manganese ions, magnesium ions, iron ions, copper ions, nickel ions, zinc ions, chromium ions.

14. A use of the graphene composite material modified with coordinating group of claim 2, characterized by being used to adsorb at least one of following heavy metals in wastewater treatment equipment: mercury ions, cadmium ions, cobalt ions, lead ions, manganese ions, magnesium ions, iron ions, copper ions, nickel ions, zinc ions, chromium ions.

15. A use of the graphene composite material modified with coordinating group of claim 3, characterized by being used to adsorb at least one of following heavy metals in wastewater treatment equipment: mercury ions, cadmium ions, cobalt ions, lead ions, manganese ions, magnesium ions, iron ions, copper ions, nickel ions, zinc ions, chromium ions.

16. A use of the graphene composite material modified with coordinating group of claim 4, characterized by being used to adsorb at least one of following heavy metals in wastewater treatment equipment: mercury ions, cadmium ions, cobalt ions, lead ions, manganese ions, magnesium ions, iron ions, copper ions, nickel ions, zinc ions, chromium ions.

17. A method to remove heavy metal ions from wastewater contaminated by heavy metal, characterized by comprising:
(i) arranging the graphene composite material modified with any coordinating group of claim 1 in a filter;
(ii) allowing the wastewater contaminated by heavy metal pass through the filter, wherein the graphene composite material modified with coordinating group can adsorb the heavy metal comprising at least one of mercury ions, cadmium ions, cobalt ions, lead ions, manganese ions, magnesium ions, iron ions, copper ions, nickel ions, zinc ions, chromium ions in the wastewater;
(iii) degrading the heavy metal by photodegradation of the graphene composite material modified with coordinating group.

18. A method to remove heavy metal ions from wastewater contaminated by heavy metal, characterized by comprising:
(i) arranging the graphene composite material modified with any coordinating group of claim 2 in a filter;
(ii) allowing the wastewater contaminated by heavy metal pass through the filter, wherein the graphene composite material modified with coordinating group can adsorb the heavy metal comprising at least one of mercury ions, cadmium ions, cobalt ions, lead ions, manganese ions, magnesium ions, iron ions, copper ions, nickel ions, zinc ions, chromium ions in the wastewater;
(iii) degrading the heavy metal by photodegradation of the graphene composite material modified with coordinating group.

19. A method to remove heavy metal ions from wastewater contaminated by heavy metal, characterized by comprising:
(i) arranging the graphene composite material modified with any coordinating group of claim 3 in a filter;
(ii) allowing the wastewater contaminated by heavy metal pass through the filter, wherein the graphene composite material modified with coordinating group can adsorb the heavy metal comprising at least one of mercury ions, cadmium ions, cobalt ions, lead ions, manganese ions, magnesium ions, iron ions, copper ions, nickel ions, zinc ions, chromium ions in the wastewater;
(iii) degrading the heavy metal by photodegradation of the graphene composite material modified with coordinating group.

20. A method to remove heavy metal ions from wastewater contaminated by heavy metal, characterized by comprising:
(i) arranging the graphene composite material modified with any coordinating group of claim 4 in a filter;
(ii) allowing the wastewater contaminated by heavy metal pass through the filter, wherein the graphene composite material modified with coordinating group can adsorb the heavy metal comprising at least one of mercury ions, cadmium ions, cobalt ions, lead ions, manganese ions, magnesium ions, iron ions, copper ions, nickel ions, zinc ions, chromium ions in the wastewater;
(iii) degrading the heavy metal by photodegradation of the graphene composite material modified with coordinating group.
